(19) United States
(12) Patent Application Publication
(10) Pub. No.: US 2008/0135589 A1
(43) Pub. Date: Jun. 12, 2008

(54) Hunter's smart seat

(76) Inventors: Sherrill Ashton McCuin, Georgia, VT (US); Ruth May McCuin, Georgia, VT (US)

Correspondence Address: Ruth M. McCuin, 77 Rock Island Road, St. Albans, VT, 05478, US

(21) Appl. No.: 11/636,705

(22) Filed: Dec. 11, 2006

(51) Int. Cl. A61G 1/017

(52) U.S. Cl. 224/160; 224/159

(57) ABSTRACT

The Hunters Smart Seat: A support devise that connects between two stationary objects via one-inch webbing circumjacent to said objects then looped through welded steel O-rings secured on each end of the seat, which may be placed at various heights, adjustable to the user's comfort through elevation of the weight carrying straps. The comfort design is directly related to the inclusion of a foam insert between two fiberglass rods fabricated into the seating portion, keeping the fabric elongated without affecting width. The essential structure of the seat is durable, lightweight and flexible. Portability is accommodated by a seat enclosure containing all paraphernalia, fabricated of the same material, connected to a person via external webbed belt loops.

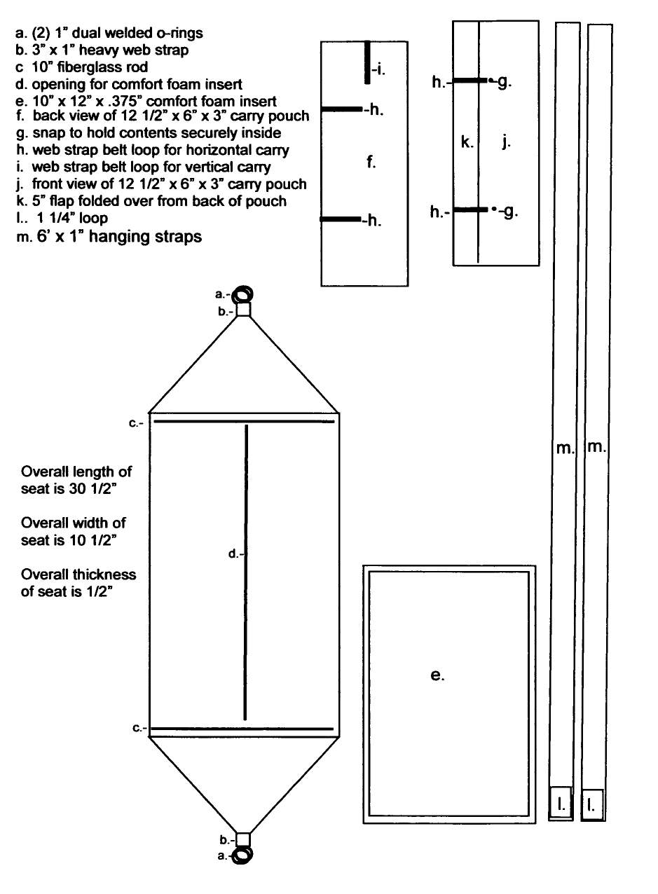

The Hunter's Smart Seat, when set up to use, creates a seat that is suspended off from the ground without using any buckles or ratchets for installation, and does not require legs or braces for this elevated seating position. Webbed straps and o-rings secure the seat.

All items for assembled ready to use product come in a compact Carry Pouch. Total package includes:
A very portable 12½″×6″×3″ compact Carry Pouch with two different types of attachment loops (for use with a standard waist belt) for vertical or horizontal carry.
A Smart Seat, unrolled/unfolded dimensions: 30½″×10½″×½″
Two Hanging straps: Strap dimensions—6′×1″. Each strap has a straight cut fused (heat-sealed) end with the opposite end of the strap sewn into a loop creating a loophole size of 1¼″. The strap is sewn using a box cross stitch for enhanced durability to create the loop.
A fabric covered Foam Comfort insert: Insert dimensions: 10″×15″×¼″ Contains a ¼″ thick, two-pound weight, polyethylene EVA foam pad cut to a dimension of 10″×15″, completely enclosed in a nylon fabric cover.

The hanging straps are connected to two anchors (i.e. a tree.) The strap is installed at a height of zero to four feet up from the base of the anchor. The straps are connected to the anchor (i.e. a tree) by looping the strap around the anchor and inserting the straight cut end through the loop end of strap and firmly tightened. The seat contains two sets, one set on each end, of welded o-rings which are sewn into a connection loop created by 1″×3″ web strapping, stitched in place using a box-cross stitch. The non-looped end of the strap is then inserted through one set of o-rings, which are sewn in a stationary position at the end of the seat. The strap is then inserted back through a single o-ring to create a firm link of the o-rings. These steps are repeated using the second anchor, the second strap, and opposite end of the seat to complete installation.

The connection loop is sewn into the two fabric layers of the seat on the end of seat. This design creates a stable loop for holding the o-rings in place. This also enhances the overall durability of the seat by transitioning from the upholstery rated fabric to a heavy-duty web strap, which is doubled over, and sewed on each side and re-enforced with a box cross stitching.

The Smart Seat is sewn to form a 5½″ over-lapping opening, easily allowing the insertion and removal of the Fabric Covered Foam Comfort Insert. This design also holds the insert in place while the seat is in use.

The Fabric Covered Foam Comfort Insert creates a padded seat within a seat. Both seats are used simultaneously to enhance overall comfort and durability. When combined, the user is supported by four layers of fabric and a ¼ inch thick two-pound weight polyethylene EVA foam pad.

The seat contains two 5/16″×10″ fiberglass rods protected on each end with one-inch vinyl caps: These rods, strategically placed at each end of the seat, maintain a flat seating surface, reduce fabric bunching, preserve overall seat surface area during use, and increase the structural durability of the seat by absorbing stress created by the reduction of a 10½ inch seat to a 1 inch web strap secured by welded o-rings.

The 10″ fiberglass rods are sewn into the seat with stitching around the entire perimeter of rod, resulting in limited rod movement, enhanced durability of transitional area and fewer loose parts. Loose meaning any objects that are not directly sewn to the seat.

The Carry Pouch
The back side of the carry pouch has an additional 5 inches of fabric that is not sewn, forming a flap that folds over the front, creating a closed unit. There is a single loop attachment of 3½″×1″ web strap sewn into side seam to form a 2½″ belt loop for carrying the pouch vertically. The loop is centered vertically on the right hand side of the back of the pouch.
A set of attachment loops for carrying the pouch horizontally are created by using two 8″×1″ web straps which have one end sewn to the pouch back; the opposite end has a ½″ snap-fastener. These are designed to insert under a person's belt and then secured by snap-fastener to the front of the pouch to create the loop. Each 8″ strap contains one female snap-fastener positioned on the non-connected end of the strap. These straps are centered horizontally of the pouch back with a minimum of a 5″ interior separation. The snap-fastener studs are positioned and attached in a similar manor on the front of the carry pouch. Carry pouch can be snap-fastened shut, enclosing all seat components.

What is claimed is:

1. The Hunter's Smart Seat does not require any buckles, ratchets or other appendages for installation other than one inch webbing straps as defined in claim number 1.

2. The Hunter's Smart Seat does not require legs or mechanical configurations for elevated seating on various types of terrain be it even, uneven, flooded timber, mud, etc; as stipulated in claim number 1.

3. The Hunter's Smart Seat is vertically adjustable starting at slightly above ground level up to four feet by utilizing the one inch webbing circumfluent to two stationary objects and looped back between two one inch welded O rings attached at each end of the seat as described in claim number 2.

4. The Hunter's Smart Seat is designed for variable curvature by means of adjusting the proximity of the anchor points to the O rings which affects the flex of the seat as indicated under means of suspension in claim number 2.

5. The Hunter's Smart Seat can be secured on two different sized trees, similar stationary objects or an overhead support allowing for a minimum separation of 12 inches between the straps, with sufficient resistance capable of holding itself in a stable position providing each object has a circumference not exceeding 4½ feet as referred to in claim number 1.

6. The Hunter's Smart Seat does not have or require a foot platform for use, safety, or comfort because the user independently adjust the height so their feet can rest on the ground, concurrent with claim number 1.

7. The Hunter's Smart Seat, once placed at the proper height level for the user, may be sat on as in the manner of a stool, chair, swing or straddled, similar to placing ones legs over a saddle for the sole comfort of the individual as related to claim number 1.

8. The Hunter's Smart Seat portability is facilitated by a convenient carry pouch which connects to the carrier via a one inch belt loop placed to carry the seat in a vertical position or by two snap closures looped over the belt attaching to the pouch in a horizontal manner as referred to in claim number 3.

9. The Hunter's Smart Seat's “quick hang O ring to webbing strap concept” is quiet and allows for quick installation; with experienced users able to complete necessary procedures in less than two minutes concordant with claim number 1.

10. The Hunter's Smart Seat's comfort to the user is enhanced by a fabric covered ⅜ inch polyethylene EVA foam insert, which when placed within the confines of the seat covering, supports the user with four layers of fabric and a foam pad relative to claim number 3.

11. The Hunter's Smart Seat's foam insert is complimentary to the seat and is easily positioned for individual preference staying in position without the use of any apparatus whatsoever as described in claim number 3.

12. The Hunter's Smart Seat is lightweight, weighing just slightly over one pound, is crafted using quiet, abrasion resistant, upholstery rated fabric and is fully functional without the EVA foam comfort insert as described in claim number 2.

13. The Hunter's Smart Seat has two 10 inch fiberglass rods, complete with vinyl end caps, sewn into the seating portion at opposite ends to add strength at the stress areas while maintaining the width and comfort while the seat is in use as is directly related to claim number 2.

14. The Hunter's Smart Seat's “quick hang concept” is environmentally friendly utilizing one inch webbing, causing no harm to the trees and by the nature of its' suspension when in use will not have an adverse affect on local flora which is relative to claim number 1.
